(19) United States
(12) Patent Application Publication
(10) Pub. No.: US 2007/0113064 A1
(43) Pub. Date: May 17, 2007

(54) Method and system for secure code patching

(76) Inventors: Longyin Wei, San Diego, CA (US); Iue-Shuenn I. Chen, San Diego, CA (US); Yuqian C. Wong, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/281,115

(22) Filed: Nov. 17, 2005

(51) Int. Cl. G06F 15/177

(52) U.S. Cl. 713/1

(57) ABSTRACT

Certain embodiments of a method and system for secure code patching may comprise modifying execution of boot code in an on-chip ROM during booting of the chip. Patch code resident in memory internal to the chip may be used to modify execution of the boot code. The address bus may be monitored for boot code addresses that match break addresses stored within the chip. If a match occurs, a start address that corresponds to the matched break address may be used to jump to a portion of the patch code. Accordingly, there may be a break in execution of the boot code, and a portion of the patch code may be executed. An instruction at the end of the portion of the patch code that is executed may be used to return to the boot code.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to boot code. More specifically, certain embodiments of the invention relate to a method and system for secure code patching.

### BACKGROUND OF THE INVENTION

As the demand for cable TV and satellite TV services increases, a greater number of set-top boxes will be needed for cable TV and satellite TV subscribers. In order to reduce cost, the cable TV and satellite TV set-top box vendors are trying to limit the cost of the set-top boxes. Reduction of the number of chips used and/or the size of chips, and reduction of the size of printed circuit board (PCB) real estate may help reduce cost.

Many set-top box vendors have used boot code stored in a ROM section of an on-chip processor. However, this may be problematic when the boot code has bugs. Whenever this happens, the ROM portion of the processor may have to be re-masked, and the processor replaced. This may be a costly process, especially in cases where the network devices are widely distributed and/or deployed. An alternative may be to use an off-chip memory for the new boot code. However, the large ROM or NVRAM required may be too expensive. Additionally, some applications may not wish to expose the boot code by placing it in an external memory.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for secure code patching, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary processing system, which may be utilized in connection with an embodiment of the invention.

FIG. 2 is a block diagram of an exemplary integrated circuit chip comprising on-chip ROM boot code and on-chip RAM patch code, in accordance with an embodiment of the invention.

FIG. 3a is a block diagram of an exemplary system comprising patch logic, in accordance with an embodiment of the invention.

FIG. 3b is a diagram of an exemplary register block in FIG. 3a, in accordance with an embodiment of the invention.

FIG. 4a is a flow chart illustrating exemplary steps for flow of boot code, in accordance with an embodiment of the invention.

FIG. 4b is a diagram illustrating exemplary steps for executing patch code, in accordance with an embodiment of the invention.

FIG. 5a is a diagram illustrating exemplary boot code and patch code, in accordance with an embodiment of the invention.

FIG. 5b is a flow chart illustrating exemplary steps for execution of boot code and patch code in FIG. 5a, in accordance with an embodiment of the invention.

### DETAILED DESCRIPTION OF THE INVENTION

Certain embodiments of the invention may be found in a method and system for secure code patching. Aspects of the method may comprise modifying execution of boot code resident in on-chip ROM during booting of the chip. Patch code resident in on-chip memory may be used to modify execution of the boot code. During the boot process, presence of valid patch code in the on-chip memory may be verified. This may be accomplished by determining whether information in a register block indicates if patch code needs to be executed. If there is no need for the patch code, the boot process may continue.

If a patch code is to be executed, a determination may be made as to whether one or more enable bits that corresponds with the patch code may be asserted. If all enable bits that correspond with the patch code are asserted, the boot process may continue. If not, the boot code may poll the enable bits until enable bits that correspond to the patch code are asserted. The boot code may then continue to execute. Portions of the boot code may be skipped and corresponding patch code segments may be executed in place of the skipped boot code. The portions of boot code to be skipped may be determined by monitoring boot code addresses output by an on-chip processor. If a monitored boot code address matches an address in the register block, a patch code address may be communicated to the on-chip memory where the patch code is stored.

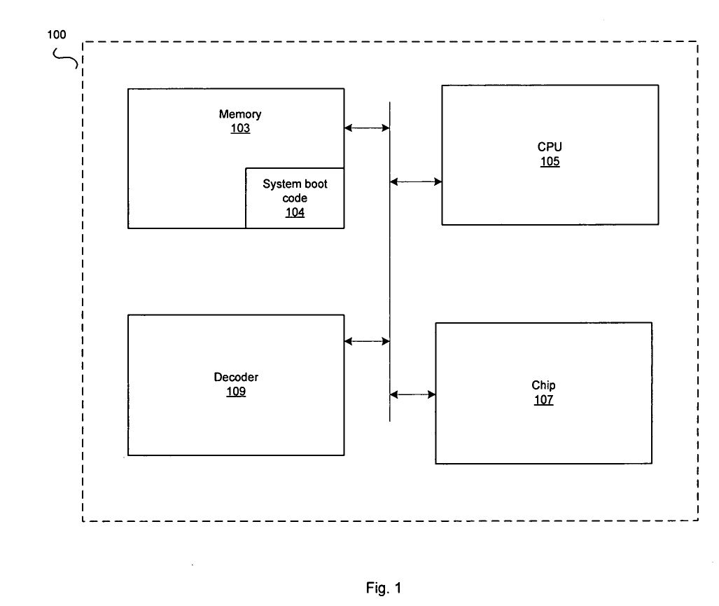

FIG. 1 is a block diagram illustrating an exemplary processing system, which may be utilized in connection with an embodiment of the invention. Referring to FIG. 1, there is shown a set-top box 100 comprising exemplary components such as a memory block 103, a CPU 105, a chip 107, and a decoder 109. In one embodiment of the invention, the chip 107 may be a security chip. The CPU 105 may communicate with the memory block 103, the chip 107, and the decoder 109 via a system bus, for example. The decoder 109 may be, for example, a MPEG decoder or a satellite TV decoder.

The memory block 103 may comprise suitable logic, circuitry, and/or code that may store data The data stored in the memory block 103 may be accessed by other processing blocks, for example, the CPU 105. The memory block 103 may also store a system boot code 104.

Upon power up of the set-top box 100, or upon a reset of the set-top box 100, the CPU 105 may execute the system boot code 104. The CPU 105 may comprise suitable logic, circuitry, and/or code that may process data that may be read from, for example, the memory block 103. The CPU 105 may store data in the memory block 103, and/or communicate data, status, and/or commands with other devices in the set-top box 100, for example, the chip 107.

The chip 107 may comprise suitable logic, circuitry, and/or code that may be adapted for use in allowing a subscriber to receive, for example, certain programming. For example, the set-top box 100 may contain information that allows access to certain portions of the set-top box 100 to validate reception of premium programming and/or pay-per-view programming. This may be accomplished through usage of an access key that may be stored in the chip 107.

The decoder 109 may comprise suitable logic, circuitry, and/or code that may be adapted to receive compressed video and or audio digital data and decompress, or decode, the digital data. The resulting decoded data may be stored, for example, in the memory block 103.

Some embodiments of the invention may utilize the CPU 105 where the CPU 105 may be an embedded processor in a chip that may have other functionalities. For example, the chip on which the CPU 105 is embedded may comprise some or all of the circuitry from the decoder 109, and some memory.

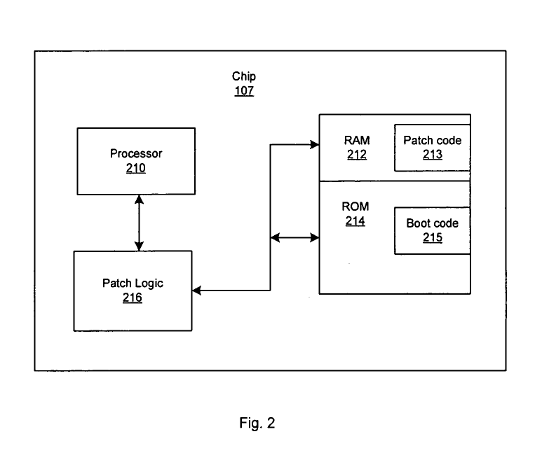

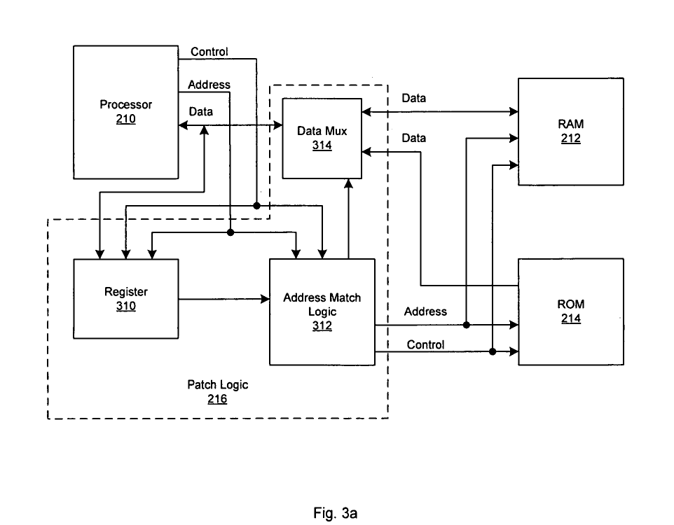

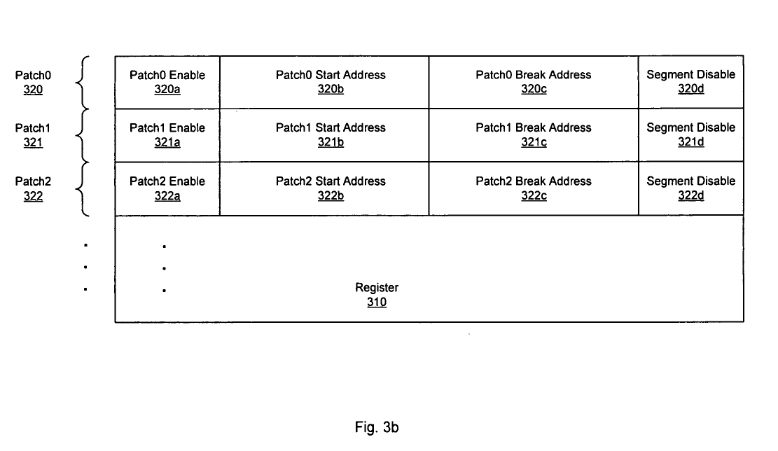

FIG. 2 is a block diagram of an exemplary integrated circuit chip comprising on-chip ROM boot code and on-chip RAM patch code, in accordance with an embodiment of the invention. Referring to FIG. 2a, there is shown the chip 107 that may comprise a processor 210, RAM 212, ROM 214, and patch logic 216. The processor 210 may use boot code 215 in the ROM 214 and the patch code 213 in the RAM 213 to boot the chip 107. The processor 210 may use the RAM 212 to temporarily store data, for example, for use while the chip 107 is powered up. The patch logic 216 may comprise logic, circuitry, and/or code that may enable execution of patch code 213 and to bypass execution of faulty code in the boot code 215. The patch logic is described in more detail with respect to FIGS. 3a and 3b.

During boot-up, the processor 210 may execute boot code 215 in the ROM 214. The patch logic 216 may monitor read addresses output by the processor 210. If a read address matches a ROM 214 address stored in the patch logic 216, the patch logic 216 may instead fetch data from the patch code 213 in the RAM 212. The read address from the processor 210 may be a starting address of a portion of the boot code 215 that may have bugs. The data fetched from the patch code 213 may be code that may replace the portion of the boot code 215 that may contain the bugs. Accordingly, a portion of the patch code 213 may be executed in place of the boot code 215 that contains the bugs. When the portion of patch code 213 that corresponds to a portion of the boot code 215 comprising the bugs finishes executing, a jump instruction may be executed to jump to a portion of the boot code 215 to continue the boot-up process.

FIG. 3a is a block diagram of an exemplary system comprising patch logic, in accordance with an embodiment of the invention. Referring to FIG. 3a, there is shown the processor 210, the RAM 212, the ROM 214, and the patch logic 216. The patch logic 216 may comprise a register block 310, an address match logic block 312, and a data multiplexer block 314. The patch code 213, which may comprise at least one patch code segment, may be stored in the RAM 212. For example, during a system boot of the set-top box 100, the CPU 105 may execute the system boot code 104. A portion of the system boot code 104 may be executed to write the patch code 213 in the RAM 212. The CPU 105 may also write break addresses and start addresses to the register block 310. The break address may be an address of the first instruction in a segment of the boot code 215. That segment of the boot code 215 may contain bugs, and therefore may need to be replaced. The start address may be an address of a segment of the patch code 213 that may replace a buggy segment of the boot code. The CPU 105 may also assert at least one enable bit after writing the patch code 213 in the RAM 212.

The register block 310 may comprise a plurality of registers that may be used to store information for at least one patch code segment. The information in the register block 310 may be used during execution of the boot code 215 to determine which segment of the boot code may be skipped and which patch code segment may be executed in place of the skipped boot code segment. The information in the register block 310 may be written by, for example, the CPU 105. The register block 310 may be described in more detail with respect to FIG. 3b.

The address match logic block 312 may comprise suitable logic, circuitry, and/or code that may be utilized when determining whether a ROM address output by the processor 210 matches a break address stored in the register block 310. If a break address matches a ROM address, the address match logic block 312 may temporarily disable access to the ROM 214. The address match logic block 312 may instead output an address to read data from the RAM 212. The RAM address that data is read from may be part of the patch code segment that corresponds to the ROM address that matched the break address. The address match block 312 may communicate control signals to the data multiplexer block 314 to select data from the RAM 212.

If the ROM address does not match any break addresses that may be stored in the register block 310, the address match logic block 312 may allow the ROM address to be communicated to the ROM 214. The address match logic block 312 may communicate control signals to the data multiplexer block 314 to select data from the ROM 214. The address match logic block 312 may not intercept a RAM read address or a RAM write address since the boot code 215 may not be present in the RAM. The data multiplexer block 314 may comprise suitable logic, circuitry, and/or code that may be utilized when multiplexing data read from the RAM 212 and the ROM 214 to the processor 210. The data multiplexer 314 may not affect data written to the RAM 212.

In operation, the address, data, and control busses may be routed to/from the processor 210 to the patch logic 216, and to/from the patch logic 216 to the RAM 212 and the ROM 214. In this manner, the patch logic 216 may monitor addresses output by the processor 210. If the monitored addresses do not match any break addresses, the address, data, and control signals may be communicated from the processor 210 to the RAM 212 and/or the ROM 214 transparently through the patch logic 216. However, if a monitored address matches, for example, a break address in the register block 310, new address and/or control signals may be communicated from the patch logic 216 to the RAM 212 and/or the ROM 214.

In accordance with an exemplary embodiment of the invention, the address match logic block 312 in the patch logic 216 may compare addresses from the processor 210 to the break addresses stored in the register block 310. The break addresses in the register block 310 may be starting addresses for segments of the boot code 215 resident in the ROM 214. A break address may be a start address for a segment of the boot code that may need to be replaced by a patch code segment. The segment to be replaced may comprise one or more bugs. This may occur if a segment of the boot code 215 contains bugs, or if additional functionality may need to be added to the boot code 215. The boot code segments indicated by the break addresses may be code that may need to be replaced by patch code segments in the patch code 213.

If the address match logic 312 determines that an address output by the processor 210 matches a break address, a patch code start address that may correspond to the detected break address may be output on the address bus. Accordingly, the address on the address bus to the RAM 212 and the ROM 214 may not be the address output by the processor 210. Additionally, since the address from the processor 210 may be a ROM address, while the start address may address a RAM location, some control signals from the processor 210 may need to be suppressed and/or new control signals for the RAM 212 may need to be generated. For example, control signals such as a ROM chip select and/or ROM output enable may not be propagated to the ROM 214. In place of these ROM control signals, control signals for the RAM 212 may be output to the RAM 214. The RAM control signals may be, for example, RAM chip select and/or RAM output enable signals. Additionally, if the RAM 212 requires multiplexed addresses, the start address to the RAM 212 may need to be multiplexed appropriately.

The instruction addressed by the start address may be read from the RAM 212. The instruction from the RAM 212 may be multiplexed by the data multiplexer 314 and communicated to the processor 210. The processor 210 may execute the instruction. While patch code segments from the RAM 212 may be executed in place segments of the boot code 215 during some ROM read operations, read and write operations to the RAM 214 may not be interfered with by the patch logic 216.

Some embodiments of the invention may not implement the data multiplexer block 314. For example, if the RAM 212 and the ROM 214 are designed such that both cannot drive the data bus at the same time, the data multiplexer block 314 may not be utilized. Additionally, although only the processor 210, the RAM 212, and the ROM 214 are shown, the invention need not be so limited. For example, there may be other circuitry and/or logic such as an external bus interface that may need to be coupled to the processor 210, the RAM 212, and/or the ROM 214.

FIG. 3b is a diagram of an exemplary register block in FIG. 3a, in accordance with an embodiment of the invention. Referring to FIG. 3b, there is shown the register block 310, which may comprise a plurality of registers Patch0 320, a register Patch1 321, and a register Patch2 322. Each of the registers Patch0 320, Patch1 321, and Patch2 322 may comprise four fields, for example. The first field may be an enable field, the second field may be a start address field, the third field may be a break address field, and the fourth field may be a segment disable field. The enable field, for example, Patch0 Enable 320a, Patch1 Enable 321a, or Patch2 Enable 322a, may comprise a single bit that may be asserted by the CPU 105 after the CPU 105 writes a segment of the patch code 213 that corresponds to the register Patch0 320, Patch1 321, or the Patch2 322.

The CPU 105 may write to the start address field, for example, Patch0 Start Address 320b, Patch1 Start Address 321b, or Patch2 Start Address 322b. The address in the start address field may be an address that may be a starting address for a segment of the patch code 213 that corresponds to the register Patch0 320, Patch1 321, or the Patch2 322. The CPU 105 may also write to the break address field, for example, Patch0 Break Address 320c, Patch1 Break Address 321C, or Patch2 Break Address 322c. The address in the break address field may be an address that may be a starting address for a segment of the boot code 215 that may be skipped because it has bugs.

Some embodiments of the invention may comprise at least one segment disable bit, for example, the segment disable bit 320d, 321d, or 322d, that may disallow writing to the start address field and/or the break address field associated for the segment associated with that segment disable bit. The segment disable bit may be a one-time programmable bit. Accordingly, the segment disable bit may not be deasserted once it is asserted. Although a separate segment disable bit may be shown for each segment in an embodiment of the invention, the invention need not be so limited. Depending on design, segment disable bits may be used to disable usage of segments of the patch code 213, or a single disable bit may disable usage of the patch code 213.

If a segment disable bit is not asserted for a segment, the address fields and/or the break address fields may be written for that segment. However, these fields may only be written once. A hardware circuitry, for example, in the register block 310, may monitor the start address fields and/or the break address fields, and may not allow further writes to a field that has already been written. Although an embodiment of the invention may be described with respect to FIG. 3b, the invention need not be so limited. For example, in other embodiments of the invention, there may not be a separate enable bit for each register in the register block 310. In this regard, a single enable bit may be utilized, and this enable bit may be asserted whenever the patch code 213 is copied or written to the RAM 212.

Some embodiments of the invention may utilize a smaller number of bits for the start address fields and/or the break address fields than the number of bits on the address bus. For example, the address bus may require 32 bits for an address. However, the design of the patch code may be such that it will be loaded to a particular portion of the RAM 214. This address space may be from 0x4000 to 0x4FFF. Accordingly, only 12 bits may be utilized in the start address fields. In accordance with an exemplary embodiment of the invention, if only 4-byte word accesses are utilized to access the patch code 213, then only 10 bits may be needed in the start address fields. The other address bits may be set to a one or to a zero when a patch code address is placed on the address bus since only the lower 12 bits of address may change for accesses to instructions in the patch code 213.

Similarly, the boot code 215 in the ROM 214 may be in the address range of 0x0000 to 0x3FFF. Accordingly, in this case, at most 14 bits of address may be needed for the break address fields. However, in order to use the reduced number of bits for the break address fields, the address match logic block 312 may need to be disabled once the boot code is completed. This may prevent unwanted address matches when address ranges beyond the boot code address range is accessed.

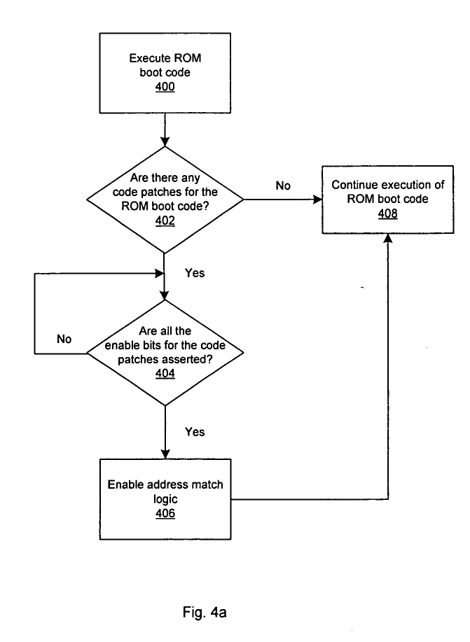

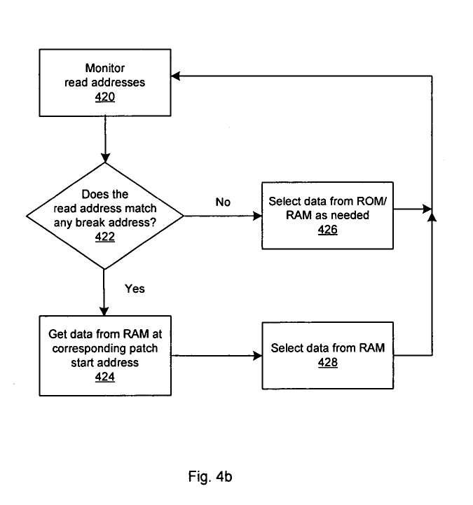

FIG. 4a is a flow chart illustrating exemplary steps for flow of boot code, in accordance with an embodiment of the invention. Referring to FIG. 4a, there is shown the steps 400, 402, 404, 406, and 408 that may be used to execute the boot code 215. In step 400, the processor 210 may execute boot code 215 in the ROM 214. This may occur after a reset of the processor 210. The reset may be a power-up reset or a software reset. With a power-up reset, the rising voltage of the power supply after the power supply is turned on may be used to generate a reset signal that enables the processor 210 to load instructions from a pre-determined address. This address may be the start address of the boot code 215 in the ROM 214. The reset signal may be used by other circuitry in the chip 107 to initialize the circuitry to known states. For example, the address match logic block 312 may be disabled by the reset signal in some embodiments of the invention.

For a soft reset, the processor 210 may execute an instruction to load the instruction at the start address of the boot code 215. This instruction may be executed by the processor 210. The soft reset may be, for example, due to a command by the CPU 105. Some embodiments of the invention may disable at least the address match logic block 312 prior to executing a soft reset.

In step 402, the processor 210 may execute boot code 215 instructions to determine whether there are any patch codes that may need to be executed. If there is patch code that needs to be executed, then at least one register in the register block 310 may have been written with appropriate break address and start address. The data in the register block 310 may be read to determine whether any of the start address fields and/or any of the break address fields of the register block 310 may comprise bits that are not set to zero. The register block 310 may, for example, comprise bits that are zeros before any data is written to the register. Alternatively, other embodiments of the invention may have bits in the register block 310 set to ones before any data is written to the register block 310. Accordingly, for this case, in order to determine whether any register has been written to, the processor 210 may need to determine whether any bits in the start address fields or the break address fields in the register block 310 are set to zeros.

If it is determined that there is no patch code, the next step may be step 408. Otherwise, the next step may be step 404. In step 404, the processor 210 may execute boot code 215 instructions to determine whether the enable bits may be asserted for the registers in the register block 310 that indicate corresponding code patch segments. If the enable bits for the corresponding code segments are not asserted, the processor 210 may loop until all of the enable bits for the corresponding code segments are asserted. Otherwise, the next step may be step 406.

In step 406, the processor 210 may execute boot code 215 instructions to enable the address match logic 312. In step 408, the processor 210 may continue to execute boot code 215 instructions in the ROM 214.

FIG. 4b is a diagram illustrating exemplary steps for executing patch code, in accordance with an embodiment of the invention. Referring to FIG. 4b, there is shown steps 420, 422, 424, 426, and 428 that may be used to execute patch code 213 instructions. In step 420, the address match logic 312 may monitor the address bus to determine if the processor 210 may be reading any data from the boot code 215 in the ROM 214. In step 422, if an address from the processor 210 does not match an address in the break address fields, for example, the break address fields 320c, 321c, and 322c of the register block 310, the next step may be step 426. Otherwise, the next step may be step 424.

In step 426, the address match logic block 312 may generate at least one control signal that may allow the data multiplexer block 314 to select data from the RAM 212 or the ROM 214. The generation of the control signal may depend on whether the address output by the processor 210 may be a ROM address or a RAM address. In step 424, the address match logic 312 may output to the address bus the address in the start address field of the register that corresponds to the break address field that supplied the matching address. The address match logic 312 may also generate new control signals to read data from the RAM 212. In step 428, the address match logic block 312 may generate at least one control signal that may allow the data multiplexer block 314 to select data from the RAM 212.

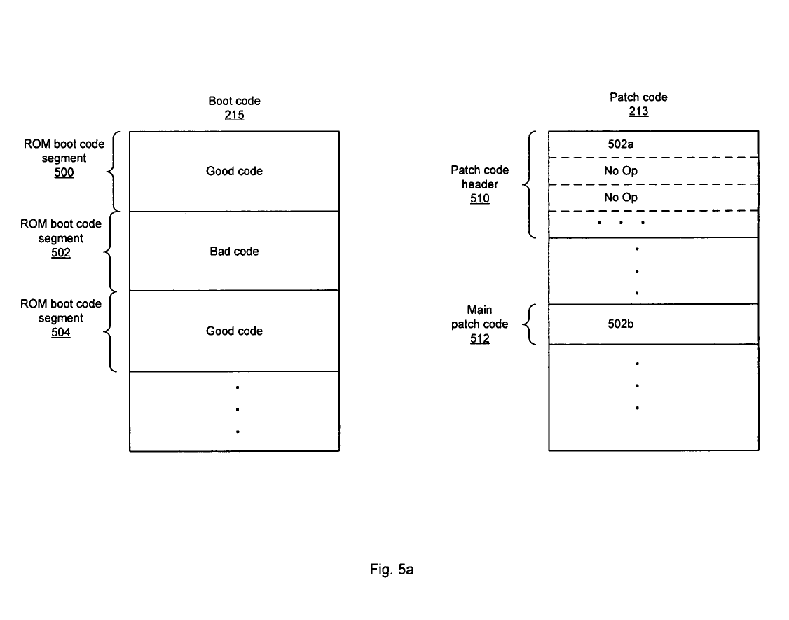

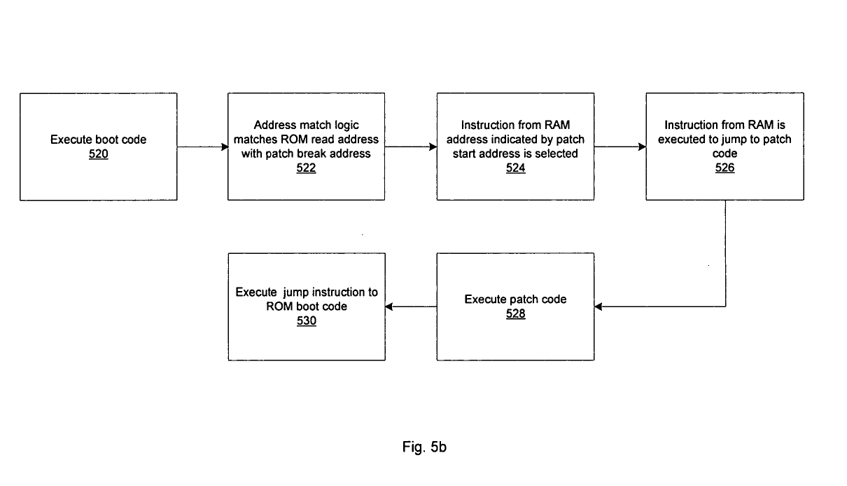

FIG. 5a is a diagram illustrating exemplary boot code and patch code, in accordance with an embodiment of the invention. Referring to FIG. 5a, there is shown the boot code 215 and the patch code 213. The boot code 215 may comprise boot code segments 500, 502, and 504. The patch code 213 may comprise patch code header 510 and main patch code 512.

The boot code segments 500 and 504 may be portions of the boot code 215 that does not have bugs. The boot code segment 502 may be a portion of the boot code that may have bugs, and therefore needs to be replaced. The patch code header 510 may comprise jump instructions to a main patch code 512. Each boot code segment that needs to be replaced may correspond to one jump instruction in the patch code header 510. For example, the boot code segment 502, which comprises one or more bugs, may correspond to the jump instruction 502a in the patch code header 510. Any unused memory space in the patch code header 510 may be filled with No Op instructions.

The main patch code 512 may comprise patch code segments that may be executed in place of boot code segments. For example, the main patch code 512 may comprise a patch code segment 502b that may be executed in place of the boot code segment 502.

FIG. 5b is a flow chart illustrating exemplary steps for execution of boot code and patch code in FIG. 5a, in accordance with an embodiment of the invention. Referring to FIG. 5b, there is shown steps 520, 522, 524, 526, 528, and 530 that may be used to execute patch code 213 while executing the boot code 215. In step 520, boot code instructions may be executed. For example, the instructions in the boot code segment 500 may be executed. After executing the last instruction in the boot code segment 500, the processor 210 may attempt to fetch the first instruction in the boot code segment 502. However, the address of the first instruction may have been written to the Patch0 Break Address 320c in the register 320 by the CPU 105.

Accordingly, in step 522, the address match logic block 312 may match the address of the first instruction in the boot code segment 502 with the break address in the Patch0 Break Address 320c. The address match block 312 may then output a RAM address from the Patch0 Start Address 320b on to the address bus. The RAM address, along with appropriate control signals, may be communicated to the RAM 212, and the RAM 212 may output an instruction stored at that address. In step 526, the instruction from the RAM 212 may be selected by the data multiplexer block 314 and communicated to the processor 210.

In step 528, the processor 210 may execute the instruction. The instruction may be, for example, a jump instruction to start of the main patch code segment 502b. Execution of the jump instruction may put the jump destination address in to a program counter of the processor 210. Accordingly, the next instruction fetched by the processor 210 may be from the main patch code segment 502b. In this manner, the instructions in the main patch code segment 502b may be fetched and executed.

In step 530, the last instruction in the main patch code segment 502b may be a jump instruction to the boot code 215 in the ROM 214. For example, the jump may be to the start of the boot code segment 504. In this manner, the good boot code segment 500 may be executed. Then the patch code header 502a and the main patch code segment 502b may be executed in place of the boot code segment 502a, which comprises one or more bugs. Finally, the good boot code segment 504 may be executed.

In accordance with an embodiment of the invention, aspects of an exemplary system may comprise the patch logic 216, within, for example, the chip 107, that may detect certain instruction addresses for the boot code 215. The patch logic 216 may comprise the register block 310, which may comprise a plurality of registers 320 . . . 322. Each of the plurality of registers 320 . . . 322 may correspond to a boot code segment and/or a patch code segment, and may comprise a break address field and/or a start address field. The break address field may store a break address, which may be an address of a first instruction in a boot code segment in the boot code 215 that comprises one or more bugs. The boot code segment that may have bugs may be skipped during the boot process. The start address field may store a start address, which may be a first instruction in a patch code segment in the patch code 213. The break address field and/or the start address field, for example, may only be written once. These address fields may be written by a processor external to the chip 107, for example, the CPU 105. The CPU 105 may write the break addresses and/or the start addresses to the break address fields and the start address fields, respectively.

A processor internal to the chip 107, for example, the processor 210, may execute boot code instructions to verify whether a valid patch code may be present in the memory internal to the chip. The boot code instructions may be stored in the ROM 214 in the chip 107. The memory internal to the chip may be the RAM 212 in the chip 107. The processor 210 may continue to execute a remainder of the boot code 215 after verifying presence of the valid patch code. The processor 210 may then execute instructions to determine whether at least one enable bit that corresponds to the patch code 213 may be asserted. The enable bits may be asserted, for example, by the CPU 105 after the CPU 105 stores the patch code 213 in the RAM 212. After verifying that all enable bits that correspond to the patch code 213 may be asserted, the processor 210 may enable the address matching logic block 312.

The processor 210 may output addresses while continuing the boot process. The addresses may now be compared with the break addresses in the register block 310 by the address matching logic block 312. When the processor 210 outputs an address that matches one of the break addresses in the register block 310, the patch logic 216 may fetch an instruction at the corresponding start address. This instruction may be a jump instruction to a main portion of the patch code segment. After executing the patch code segment, a jump instruction may be executed. The jump address may be an address of the next segment of the boot code 215 that may need to be executed. The flow of the boot process may be altered in this manner.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for modifying flow of a boot routine, the method comprising modifying execution of boot code resident in ROM on a chip during booting of said chip by executing patch code resident in on-chip memory.

2. The method according to claim 1, further comprising verifying whether a valid patch code is present in said on-chip memory.

3. The method according to claim 2, further comprising continuing to execute a remainder of said boot code resident in said ROM after said verifying presence of said patch code.

4. The method according to claim 1, further comprising determining whether at least one enable bit that corresponds to said patch code is asserted.

5. The method according to claim 1, further comprising executing at least a portion of said patch code resident in said on-chip memory during said booting of said chip.

6. The method according to claim 1, further comprising executing at least a portion of said patch code in place of corresponding boot code in said ROM.

7. The method according to claim 1, further comprising writing at least one address to at least one register in said chip, wherein said at least one register corresponds to a patch code segment in said patch code and to a boot code segment in said boot code.

8. The method according to claim 7, wherein said at least one address comprises a break address of said boot code segment in said boot code.

9. The method according to claim 7, wherein said at least one address comprises a start address of said patch code segment in said patch code.

10. The method according to claim 7, wherein said register comprises a field for a break address of said boot code segment that is to be replaced and a start address for said patch code segment that is to be executed in place of said boot code segment.

11. The method according to claim 7, wherein said at least one address can only be written once to said register.

12. The method according to claim 7, further comprising disabling said writing to said at least one register in said chip.

13. The method according to claim 1, further comprising storing said patch code to on-chip RAM by an off-chip processor.

14. The method according to claim 13, further comprising asserting at least one enable bit in a register in said chip by said off-chip processor, after said off-chip processor stores said patch code in said on-chip RAM.

15. A system for modifying flow of a boot routine, the system comprising circuitry within a chip that enables detection of an address for a boot code segment in on-chip ROM, wherein said circuitry enables fetching of instructions from a patch code resident in on-chip memory to be executed in place of said boot code segment.

16. The system according to claim 15, further comprising an on-chip processor that enables verification of whether a valid patch code is present in said on-chip memory.

17. The system according to claim 16, wherein said on-chip processor continues to execute a remainder of said boot code resident in said on-chip ROM after said verification of said presence of said valid patch code.

18. The system according to claim 15, further comprising an on-chip processor that enables determination of whether at least one enable bit that corresponds to said patch code is asserted.

19. The system according to claim 15, further comprising an on-chip processor that executes at least a portion of said patch code resident in said on-chip memory during said booting of said chip.

20. The system according to claim 15, further comprising an on-chip processor that executes at least a portion of said patch code in place of corresponding portion of said boot code in said on-chip ROM.

21. The system according to claim 15, further comprising an off-chip processor that writes at least one address to at least one register in said chip, wherein said at least one register corresponds to a patch code segment in said patch code and to said boot code segment.

22. The system according to claim 21, wherein said at least one address comprises a break address of said boot code segment in said boot code.

23. The system according to claim 21, wherein said at least one address comprises a start address of said patch code segment in said patch code.

24. The system according to claim 21, wherein said register comprises a field for a break address of said boot code segment that is to be replaced and a start address for said patch code segment that is to be executed in place of said boot code segment.

25. The system according to claim 21, wherein said at least one register can only be written once.

26. The system according to claim 21, wherein said off-chip processor disables said writing to said at least one register in said chip.

27. The system according to claim 15, further comprising an off-chip processor that enables storing of said patch code to on-chip RAM.

28. The system according to claim 27, wherein said off-chip processor enables assertion of at least one enable bit in a register in said chip after said patch code is stored in said on-chip RAM.
